(19) United States
(12) Patent Application Publication
(10) Pub. No.: US 2008/0276187 A1
(43) Pub. Date: Nov. 6, 2008

(54) Iconic Programming System with Disabling and Enabling of Dependent Objects

(75) Inventors: Susan Germaine Wolber, Fort Collins, CO (US); John Francis Dumais, Loveland, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Loveland, CO (US)

(21) Appl. No.: 12/172,277

(22) Filed: Jul. 14, 2008

(51) Int. Cl. G06F 9/44; G06F 9/46

(52) U.S. Cl. 715/763

(57) ABSTRACT

An iconic network within a computer system is displayed on a display device. Portions of the iconic network within the computer system can be disabled. The computer system receives user input to disable a first graphical object. The computer system then identifies a second graphical object as dependent from the first graphical object and also disables this second graphical object. When the computer system receives user input the re-enable the first graphical object, the computer system also re-enables the second graphical object. Also the user can optionally re-enable objects that were automatically disabled because of dependencies.

### BACKGROUND OF THE INVENTION

An iconic programming system is a “programming-less” environment where programming is done by connecting graphical images of devices (icons), together with lines, to create an iconic network which represents a software program. The iconic programming system may be used in research and development test environments, where several different external electronic instruments are connected to test a system or device. Programming such a system requires instructions to cause the various external instruments to perform desired functions in order to operate as a system.

When an iconic programming system is used, each instrument is represented by a graphical object image, also called a graphical object, and the connections between the instruments are represented by connecting lines between the graphical object images. Each device may have multiple input lines connecting from other devices, bringing data into the device for it to use during its execution. Each device may also have multiple output lines connecting to other devices, to pass its new or changed data on to the other devices in the program. In addition to graphical objects representing instruments in such a system, graphical objects are provided for programming functions, for example looping, IF-THEN statements, data analysis, data display, simulated instruments, etc. By combining instrument and programming objects, a user can create an iconic network involving the programmed operation of several instruments.

When the iconic network runs, each device may use the data on its input lines, modify it, and put the same or other data on its output lines for other devices to use.

Various features and components of an iconic network system are disclosed in the following U.S. patent applications which are assigned to the same assignee as the present invention: U.S. Pat. No. 5,313,575, U.S. Pat. No. 5,261,043, U.S. Pat. No. 5,377,318, U.S. Pat. No. 5,293,476, U.S. Pat. No. 5,325,481, U.S. Pat. No. 5,551,041, U.S. Pat. No. 5,313,574, U.S. Pat. No. 5,437,007, U.S. Pat. No. 6,016,143, U.S. Pat. No. 5,754,426, U.S. Pat. No. 6,816,914 and U.S. Pat. No. 6,862,030.

Users of an iconic programming system commonly create fairly complicated and large programs, which can be a challenge to debug. In particular, many programs (graphical or otherwise) contain code that takes a large amount of time to execute, possibly from minutes to days. Sometimes a user wishes to debug a part of the program that does not include the portion of the code which requires a long execution time. Rather, the user would like to skip that portion of code and jump to the particular portion of the code that is to be debugged.

FIG. 1 shows a simple illustrative example of four graphical objects of an iconic network 100. Each of the graphical objects might perform a large chunk of work. The user might want to execute the setup steps “setup instruments” object 101 and “setup data files” object 103, skip the “get data from instruments and save to files” object 105 but debug the “analyze data” object 107. The user might want to debug the “analyze data” object 107 using already-created data files rather than the data from instruments which would usually be acquired by the “get data from instruments and save to files” object 105.

The user would like to select the “get data from instruments and save to files” object 105 so that the computer system will disable, inactivate, skip from execution or “comment-out” the object. However, the user does not want to modify the iconic program by deleting the object, rather, it is desired to skip the execution of the object temporarily.

In response to the user selecting the “get data from instruments and save to files” object 105, the graphical programming language sets a property or attribute on the “get data from instruments and save to files” object 105 to mark it for being skipped. The graphical programming language also visually shows the object as being disabled.

Additionally, groups of objects, forming a portion of the iconic network, can be disabled. For example, the user can choose both the “setup data files” object 103 and the “get data from instruments and save to files” object 105 to be disabled.

U.S. Patent Publication US2004/0012632A1 to King et al. published Jan. 22, 2008 describes a method for disabling or conditionally compiling the graphical objects. The article “New in LabVIEW 8: Diagram Disable Structure”, National Instruments Corporation, http://zone.ni.com/devzone/cda/tut/p/id/3684, 2008, describes a similar feature. Like traditional text-based languages, they prevent one portion of the iconic network from running while other portions are executed. Each portion of the iconic network can include one or more graphical objects.

Disabling a portion of an iconic network can cause problems for objects which depend from or are downstream from the disabled portion. In general, a graphical object or portion of the iconic network is said to depend from or is downstream from another object or portion if it receives any information from that object or portion.

For example, in FIG. 1, the “analyze data” object 107 depends from the “get data from instruments and save to files” object 105. If the “get data from instruments and save to files” object 105 is commented-out, then it is not clear whether or not the “analyze data” object 107 should be executed at all, and if it is executed then what “data” should it execute? Much more complicated examples posing more complicated problems can also be constructed.

It would be desirable if the computer system could identify a graphical object as dependent from another graphical object and then take appropriate action.

### SUMMARY OF THE INVENTION

The present invention allows a computer system to identify a graphical object or portion of an iconic network as dependent from another graphical object or portion of an iconic network and then take appropriate action such as disabling the dependent graphical object when the graphical object from which it depends is disabled.

An iconic network within a computer system is displayed on a display device. Portions of the iconic network within the computer system can be disabled. The computer system receives user input to disable a first graphical object. The computer system then identifies a second graphical object as dependent from the first graphical object and also disables this second graphical object. When the computer system receives user input to re-enable the first graphical object, the computer system also re-enables the second graphical object. Also the user can optionally re-enable objects that were automatically disabled because of dependencies.

### BRIEF DESCRIPTION OF THE DRAWINGS

Further preferred features of the invention will now be described for the sake of example only with reference to the following figures, in which:

FIG. 1 shows a simple illustrative example of four graphical objects of an iconic network of the prior art.

FIG. 2 shows a block diagram of a computer system incorporating the present invention.

FIG. 3 shows an iconic network of an embodiment of the present invention for implementing on the computer system of FIG. 2.

FIG. 4 shows another embodiment of the iconic network of FIG. 3.

FIG. 5 illustrates steps for disabling dependent objects of an iconic network such as the iconic network of FIG. 3.

FIG. 6 illustrates steps for re-enabling the graphical objects after they have been disabled by the method of FIG. 5.

### DETAILED DESCRIPTION

The following description is of the best presently contemplated mode of carrying out the present invention. This description is not to be taken in a limiting sense but is made merely for the purpose of describing the general principles of the invention. The scope of the invention should be determined by referencing the appended claims.

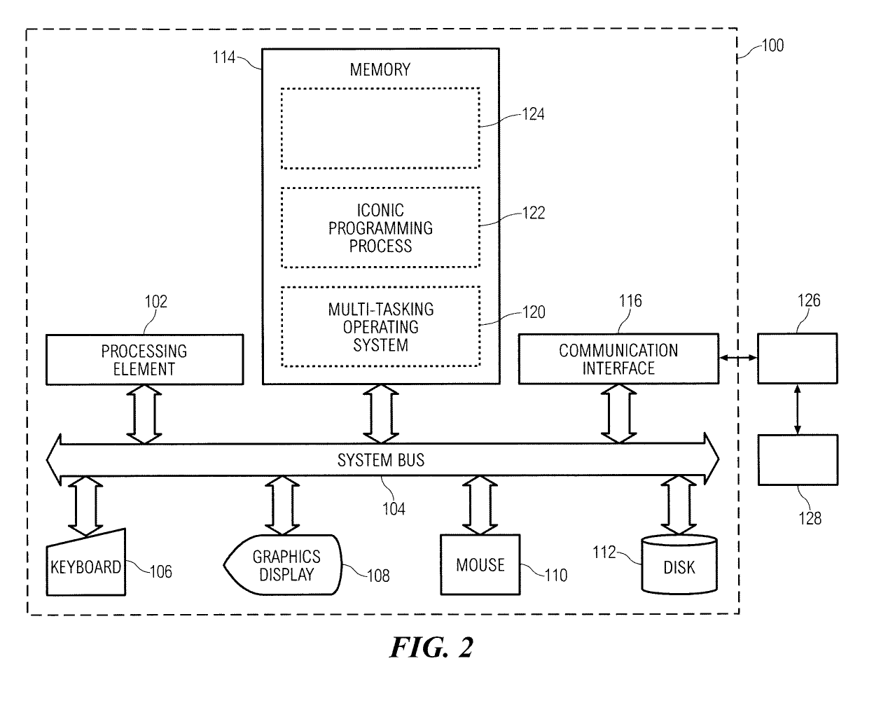

FIG. 2 shows a block diagram of a computer system incorporating the present invention. A computer system 200 contains a processing element 102 which connects to the other components of the system through a system bus 104. A keyboard 106 allows a user to input textual data to the system, and a mouse 110, or more generally any pointing device, allows a user to input graphical data to the system. A graphics display 108 allows the system to output text and graphical information to the user. A disk 112 is used by the system to store the software of the iconic programming system environment, as well as the user-defined iconic network. A communications interface 116 is used to create a communications network which allows the computer and iconic programming environment to communicate with other computers and other environments. For example, the communication thorough the communications interface 116 can be to one or more instrument 126 which can be any external test and measurement equipment, for example. Also shown is an item to be measured 128 which can be any material, device or system to be measured by the one or more instrument 126.

A multi-tasking operating system 120 can have a plurality of tasks, also called processes, here illustrated by task 122 and task 124. Task 122 contains the iconic programming process including the identification of downstream dependent objects of the present invention.

In the present disclosure, disabling one or more graphical objects forming a portion of an iconic network can be done by skipping the compiling of the particular portion while still compiling other portions of the iconic network. Alternatively or in combination, the disabling of one or more graphical objects forming a portion of an iconic network can be done by compiling the particular portion to be disabled but then skipping the execution of the particular portion. Disabling one or more graphical objects is also referred to as “commenting-out” the one or more graphical objects.

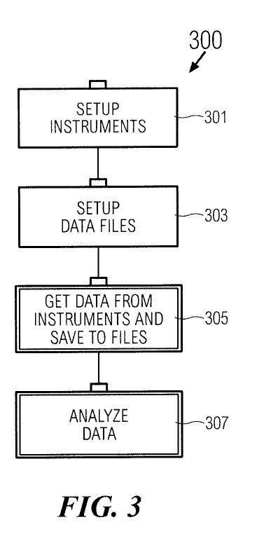

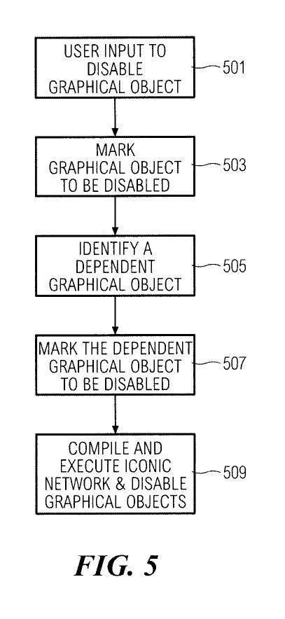

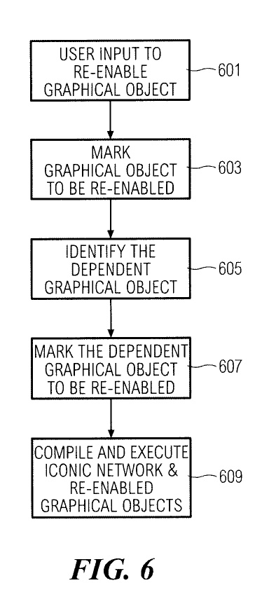

FIG. 3 shows an iconic network 300 of an embodiment of the present invention. The iconic network 300 can be a portion of a larger iconic network. FIGS. 5 and 6 are flowcharts illustrating steps for performing the method of an embodiment of the present invention. Some flowchart blocks describing the operation of iconic networks, but not necessary to explain the present invention, are excluded. Details of these additional flowchart blocks can be found in the patents mentioned in the “Background of the Invention” section above.

The iconic network 300 includes a “setup instruments” object 301, “setup data files” object 303, a “get data from instruments and save to files” object 305, and an “analyze data” object 307. The object 307 depends from the object 305, which depends from the object 303, which in turn depends from the object 301. Phrased another way, the object 307 is downstream from the object 305, which is downstream from the object 303, which in turn is downstream from the object 301.

As a general example of how the present invention functions, a user might want to execute the setup steps “setup instruments” object 301 and “setup data files” object 303 and skip the “get data from instruments and save to files” object 305. However, problems can occur if the “analyze data” object 307 is executed after the “get data from instruments and save to files” object 305 has been disabled. This is because there might be no data available for the object 307 to analyze if the object 305 has not been executed to get the data and save the data. The present invention helps prevent these problems.

FIG. 5 describes steps for disabling dependent objects of an iconic network such as the iconic network 300 illustrated in FIG. 3 according an embodiment of the present invention. At Step 501 the user inputs instructions to disable the “get data from instruments and save to files” object 305 of the iconic network 300. The user can input the instructions into the keyboard 106 or mouse 110 of the computer system 200. For example, the user can point and click on the object 305 using the mouse 110.

In response to the user selecting the “get data from instruments and save to files” object 305 to be disabled at Step 501, at Step 503 the iconic programming process 122 of the computer system 200 sets a property or attribute on the object 305 to mark it for being skipped. The graphical programming language also visually shows the graphical object 305 as being disabled. In FIG. 3 the graphical object 305 is shown with an emphasized border in response to the user input of Step 501 to indicate that it is to be skipped when the iconic network is compiled and/or executed.

At Step 505, in response to the user input of Step 501, the iconic programming process 122 identifies the “analyze data” object 307 as dependent from the “get data from instruments and save to files” object 305.

In response to the iconic programming process 122 identifying the “analyze data” object 307 as dependent from the graphical object 305, at Step 507 the iconic programming process 122 of the computer system 200 sets a property or attribute on the graphical object 307 to mark it for being skipped. The graphical programming language also visually shows the graphical object 307 as being disabled. In FIG. 3 the graphical object 307 is shown with an emphasized border in response to the user input of Step 501 and resultant determination by the iconic programming process 122 that the graphical object 307 depends from the graphical object 305.

At Step 509 the graphical objects 305, 307 are disabled if they were marked to be disabled at Steps 503 or 507. The graphical objects 305, 307 can be disabled by skipping the compilation of the objects during the compilation of the iconic network 300. Alternatively, the graphical objects can be disabled by skipping the execution of the objects as the iconic network 300 is being executed.

FIG. 6 describes steps for re-enabling the graphical objects such as the graphical objects 305, 307 after they have been disabled by the method of FIG. 5. At Step 601 the user inputs instructions to re-enable the “get data from instruments and save to files” object 305 of the iconic network 300. The user can input the instructions into the keyboard 106 or mouse 110 of the computer system 200. For example, the user can point and click on the object 305 using the mouse 110.

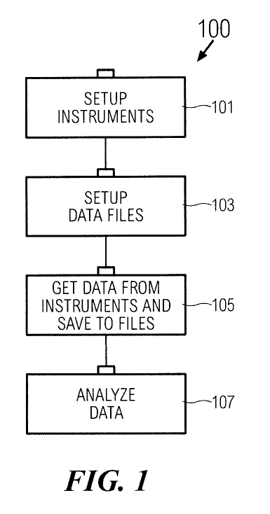

In response to the user selecting the “get data from instruments and save to files” object 305 to be re-enabled at Step 601, at the Step 603 the iconic programming process 122 of the computer system 200 sets a property or attribute on the object 305 to mark it to be executed. The graphical programming language also visually shows the graphical object 305 as being enabled. For example, in FIG. 3 the graphical object 305 would lose its emphasized border and instead would again be displayed with a normal border such as the graphical object 105 in FIG. 1.

At Step 605, in response to the marking the graphical object 305 to be re-enabled or executed at the Step 603, the iconic programming process 122 identifies the “analyze data” object 307 as dependent from the “get data from instruments and save to files” object 305 and as being marked to be disabled.

At Step 607 the iconic programming process 122 of the computer system 200 removes the property or attribute on the graphical object 307 set to mark it for being skipped. The property or attribute might also be marked for compilation or execution of the graphical object. The graphical programming language visually shows the graphical object 307 as being re-enabled. For example, the graphical object 307 would lose its emphasized border and instead would again be displayed with a normal boarder such as the graphical object 107 in FIG. 1.

At Step 609 the graphical objects 305, 307 are re-enabled if they were marked to be re-enabled at Steps 603 or 607. The graphical objects 305, 307 can be re-enabled by compiling them along with the other graphical objects during the compilation of the iconic network 300. Alternatively, the graphical objects 305, 307 can be re-enabled by executing the objects 305, 307 as the iconic network 300 is being executed.

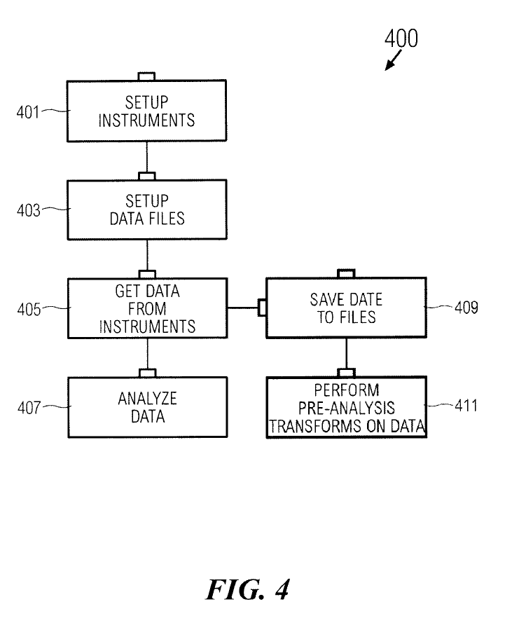

FIG. 4 shows an iconic network 400, which is another embodiment of the iconic network 300 of FIG. 3. The iconic network 400 includes a “setup instruments” object 401, “setup data files” object 403, a “get data from instruments” object 405, and an “analyze data” object 407. The object 407 depends from the object 405, which depends from the object 403, which in turn depends from the object 401. Connected to “get data from instruments” object 405 is an additional “Save Data to Files” object 409 which is downstream from and dependent from the graphical object 405. Downstream from and dependent from the object 409 is a “Perform pre-analysis transforms on data” object 411.

As in the iconic network 300, the user might want to execute the setup steps “setup instruments” object 401 and “setup data files” object 403 and skip the “get data from instruments” object 405. The user might want to debug or execute, rather than disable, the “analyze data” object 407 using already-created data files rather than the data from instruments which would usually be acquired by the “get data from instruments” object 405 and the “save data to files” object 409.

The steps for performing this embodiment of the invention are the same as described with reference to FIG. 5. However, at Step 505 the “Save Data to Files” object 409 is identified by the iconic programming process 122 as dependent from the “get data from instruments” object 405. The iconic programming process 122 additionally identifies the “Perform pre-analysis transforms on data” object 411 as dependent from the graphical object 409. And as shown previously, object 407 would also be identified as dependent from object 405.

As can be seen from FIG. 4, the user has connected the “Save Data to Files” object 409 to the “get data from instruments” object 405 using a horizontal line attached to the side of the graphical object 405. In this way the user can indicate to the iconic programming process 122 that the graphical object 409 depends from the graphical object 405 and is to be disabled or re-enabled whenever the graphical object 405 is disabled or re-enabled. Thus, the user provides the iconic programming process 122 with graphical instructions for whether or not a particular graphical object is to be treated as a dependent object for the purposes of disabling it or re-enabling it. The iconic programming process 122 can also determine that the graphical object 411 is in the same path as the graphical object 409 relative to the object 405 and thus should be treated the same way as the graphical object 409. As described above with respect to FIG. 3, objects marked to be disabled or re-enabled can be visually enhanced by the iconic programming process 122.

The user may desire to debug graphical object 407 even though the user has disabled the graphical object 405 and thus the graphical object 407 has been disabled because of its dependency. In this invention the user can choose to re-enable object 407 to allow it to be debugged. Thus, even when the graphical object 405, and also the graphical objects 409, 411, are not executed, the graphical object 407 can still be executed. The graphical object 407, receiving no data from the graphical object 405, can instead process stored data in place of receiving the data from the disabled object 405. The stored data can be data obtained earlier from the instruments or can be default data, for example.

There are examples where a user might not want to execute any graphical objects dependent from the graphical object 405, including all of the graphical objects 407, 409, 411. In the above examples this has been described as the default behavior of the system. However there are also cases as described above where the user wishes to explicitly mark one or more objects as disabled, but also mark dependent objects as re-enabled. In such a case the iconic programming process 122 can mark a different attribute to the graphical object 405 so that the graphical objects 409, 411 will be marked to be disabled while object 407 is marked as enabled. Alternatively a different attribute can be assigned to the graphical object 407 so that it is marked to be manually re-enabled after being disabled. Also, the line connecting the graphical object 407 to the graphical object 405 can be assigned an attribute to disable the graphical object 407.

In the foregoing specification, the invention has been described with reference to specific exemplary embodiments thereof. The specification and drawings are, accordingly, to be regarded in an illustrative sense rather than a restrictive sense.

1. A method for disabling portions of an iconic network within a computer system, the iconic network displayed on a display device, the method comprising the steps of:
receiving user input, by the computer system, to disable a first graphical object of the iconic network; and
identifying, by the computer system, a second graphical object as dependent from the first graphical object.

2. The method of claim 1, further comprising the steps of:
disabling the first graphical object by the computer system; and
disabling the identified second graphical object by the computer system.

3. The method of claim 2, wherein the disabling of the identified second graphical object comprises the step of skipping the compilation of the second graphical object.

4. The method of claim 2, wherein the disabling of the identified second graphical object comprises the step of skipping the execution of the second graphical object.

5. The method of claim 1, further comprising the step of processing stored data by the identified second graphical object, in place of receiving the data from the first graphical object, in response to the user input to disable the first graphical object.

6. The method of claim 1, wherein the computer system identifies the second graphical object based on a graphical connection of the second graphical object to the first graphical object.

7. The method of claim 6, wherein the graphical connection is a line.

8. The method of claim 7, wherein the computer system identifies the second graphical object based on the position at which the line is connected to the first graphical object.

9. The method of claim 2, further comprising the step of:
receiving user input, by the computer system, to re-enable the disabled first graphical object of the iconic network; and
re-enabling the disabled second graphical object, by the computer system, in response to the user input to re-enable the first graphical object.

10. The method of claim 2, further comprising the step of changing the appearance on a display device of the first graphical object in response to it being disabled and the second graphical object in response to it being identified.

11. The method of claim 2, further comprising the steps of:
receiving user input, by the computer system, to disable additional graphical objects of the iconic network;
identifying, by the computer system, dependent graphical objects as dependent from the additional graphical objects;
disabling the additional graphical objects by the computer system; and
disabling the identified dependent graphical objects by the computer system.

12. The method of claim 2, further comprising the steps of:
receiving user input, by the computer system, to re-enable the identified second graphical object of the iconic network; and
re-enabling the identified second graphical object by the computer system.

13. An iconic programming system for communicating with test and measurement instruments comprising:
graphical objects of an iconic network for display on a display device of the iconic programming system;
a user input device for allowing a user to instruct the computer system to disable a first of the graphical objects; and
a processor of the computer system for identifying a second of the graphical objects as dependent from the first graphical object.

14. The system of claim 13, wherein the processor is also for disabling the first of the graphical objects in response to the user instructions.

15. The system of claim 14, wherein the processor is also for disabling the identified second of the graphical objects when the first of the graphical objects has been disabled.

16. The system of claim 13, wherein the processor disables the first of the graphical objects by skipping the compilation of the first of the graphical objects.

17. The system of claim 13, wherein the processor disables the first of the graphical objects by skipping the execution of the first of the graphical objects.

18. The system of claim 15, wherein the processor disables the identified second of the graphical objects by skipping the compilation or the execution of the second of the graphical objects.

19. The system of claim 13, further comprising stored data, and wherein the identified second of the graphical objects processes the stored data in place of receiving the data from the first of the graphical objects, in response to the disabling of the first of the graphical objects.

20. The system of claim 13, wherein the second of the graphical objects has a graphical connection to the first of the graphical objects and the computer system identifies the second of the graphical objects based on the graphical connection of the of the first of the graphical objects to the second of the graphical objects.

21. The system of claim 20, wherein the graphical connection is a line and wherein the computer system identifies the second of the graphical objects based on the position at which the line is connected to the first of the graphical objects.

22. The system of claim 15, wherein the processor is also for re-enabling the first of the graphical objects in response to the user instructions and for re-enabling the identified second of the graphical objects when the first of the graphical objects has been re-enabled in response to the user instructions.
